(19) United States
(12) Patent Application Publication
(10) Pub. No.: US 2024/0266160 A1
(43) Pub. Date: Aug. 8, 2024

(54) GAS SAMPLING APPARATUS FOR A PHYSICAL VAPOR TRANSPORT SYSTEM

(71) Applicant: CVD Equipment Corporation, Central Islip, NY (US)

(72) Inventor: Maxim S. Shatalov, Mt. Sinai, NY (US)

(21) Appl. No.: 18/430,732

(22) Filed: Feb. 2, 2024

Related U.S. Application Data
(60) Provisional application No. 63/443,135, filed on Feb. 3, 2023.

(51) Int. Cl. H01J 49/04; H01J 49/42

(52) U.S. Cl. CPC H01J 49/0422; H01J 49/0468; H01J 49/4215

(57) ABSTRACT

Systems for providing a gas sample from a physical vapor transport system include a sampling tube with a first end connected to a crucible retort of the physical vapor transport system to sample a gas phase. The systems include a heater around at least a part of the sampling tube to maintain a temperature within the sampling tube. The sampling tube is integrated with an orifice and a skimmer with a skimmer divergent nozzle. An output of the skimmer is connected to a gas analyzer. An output of the sampling tube is connected to a differential pumping port.

### CROSS-REFERENCE TO RELATED APPLICATIONS

This application claims the benefit of, and priority to, U.S. Provisional Patent Application No. 63/443,135 filed on Feb. 3, 2023, the entire contents of which are incorporated herein by reference.

### TECHNICAL FIELD

The present disclosure generally relates physical vapor transport (PVT) systems and to novel methods of gas sampling from inside of the crucible through the lid of the crucible.

### BACKGROUND

Unless otherwise indicated herein, the materials described in this section are not prior art to the claims in this application and are not admitted being prior art by inclusion in this section.

Physical vapor transport (PVT) systems are currently used for growth of single crystal bulk SiC, AN, ZnSe, ZnSeTe, CdTe, CdS, and ZnTe materials. During the growth of SiC crystals the gas phase may predominantly consist of elemental silicon (Si) and carbon (C) and may also include Si₂C and SiC₂ compounds that exist in the gas phase at high temperatures (typically above 1400° C.). Impurities may come from a graphite hot zone, source material or process or purge gas may be present in the gas phase. Understanding the presence (or partial pressure) of various species inside the crucible as a function of source and crucible material, process temperature, process pressure, gases used during the process, and thermal gradients created inside of the hot zone may be important for creating a larger process window for depositing SiC crystals with a known crystal orientation (e.g. 4H) and low density of defects such as micropipes, dislocations, stacking faults, inversion domains, point defects and other defects.

A quadrupole mass spectrometer is a common tool used for detection of specific elements or molecules in the gas phase. Quadrupole mass spectrometer analysis provides chemical and analytical information about gas species present in a vacuum system. Analyzing the gas composition within a PVT tool under relevant SiC growth conditions may be difficult due to a large difference between process pressure (typically 10s to 100s of Torr) and high vacuum conditions required for a mass spectrometer measurement (below 10⁻⁴ Torr) and condensation of most critical species at temperatures lower than 1400° C.

### SUMMARY

Existing challenges associated with the foregoing, as well as other challenges, are overcome by the presently disclosed sampling tube for a physical vapor transport system.

One embodiment of the present disclosure is a system for providing a gas sample from a physical vapor transport system. The system includes a sampling tube with a first end connected to a crucible retort of the physical vapor transport system to sample a gas phase. The system includes a heater around at least a part of the sampling tube to maintain a temperature within the sampling tube. The sampling tube is integrated with an orifice and a skimmer with a skimmer divergent nozzle. An output of the skimmer is connected to a gas analyzer. An output of the sampling tube is connected to a differential pumping port.

In aspects, the sampling tube is a capillary tube.

In aspects, the gas analyzer is a quadrupole mass spectrometer.

In aspects, the sampling tube passes through a lid of the crucible retort.

In aspects, the sampling tube is inserted through a bottom of the crucible retort and the crucible retort is modified with an element to maintain a source material above the sampling tube.

In aspects, a source material within the crucible retort is SiC source material including a polycrystalline power, pieces of polycrystalline SiC, or a mix of high purity elemental Si and C.

In aspects, the gas phase includes Si, C, Si₂C and SiC₂.

In aspects, the heater is an inductive heater, resistive heater, or infrared heater, and heats the sampling tube to a temperature of above 1400° C.

In aspects, the differential pumping port is connected to differential pumping apparatus including a turbomolecular and/or rotary vacuum pump.

In aspects, the sampling tube with the orifice and the skimmer divergent nozzle is integrated along about a full length of the sampling tube and forms a molecular jet of gas to be analyzed.

In aspects, the sampling tube with the orifice and the skimmer divergent nozzle is integrated along a portion of a length of the sampling tube to be below the differential pumping port but does not extend into the crucible retort and form a molecular jet of gas to be analyzed.

In aspects, the sampling tube integrated with an orifice and a skimmer with a skimmer divergent nozzle are fabricated from graphite, electrically conductive high temperature ceramic, or graphite or metal coated with a high temperature ceramic layer including TaC, HfC, ZrC, TiC, WC, and/or NbC.

The present disclosure also provides a device for providing a gas sample from a physical vapor transport system. The device includes a sampling tube integrated with an orifice and a skimmer with a skimmer divergent nozzle. The device includes a heater around at least a part of the sampling tube to maintain a temperature within the sampling tube. A first end of the sampling tube is connected to a crucible retort of the physical vapor transport system to sample a gas phase. An output of the skimmer is connected to a gas analyzer. An output of the sampling tube is connected to a differential pumping port.

Another embodiment of the present disclosure includes a method for providing a gas sample from a physical vapor transport system. The method includes sampling gas from a gas phase of a crucible retort of the physical vapor transport system by a sampling tube integrated with an orifice and a skimmer with a skimmer divergent nozzle. The method includes heating the sampling tube by a heater around at least a part of the sampling tube to maintain a temperature within the sampling tube. The method includes providing the gas sample to a gas analyzer. A first end of the sampling tube is connected to the crucible retort of the physical vapor transport system, an output of the skimmer is connected to the gas analyzer, and an output of the sampling tube is connected to a differential pumping port.

### BRIEF DESCRIPTION OF THE FIGURES

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example PVT system or method that can be utilized to produce SiC bulk crystal boule growth according to the present disclosure;

FIG. 2a illustrates a sampling tube for gas sampling from inside of the crucible of a PVT system through the lid of the crucible according to the present disclosure;

FIG. 2b illustrates a sampling tube for gas sampling from inside of the crucible of a PVT system where a gas sampling tube is inserted through a bottom of a crucible modified with an element to maintain source material above the sampling tube according to the present disclosure;

FIG. 3a illustrates calculated vapor pressure vs temperature curves for Si, C, Si₂C, SiC₂ and other compounds assuming condensed SiC and C according to the present disclosure;

FIG. 3b illustrates calculated vapor pressure vs temperature curves for Si, C, Si₂C, SiC₂ and other compounds assuming condensed SiC and Si according to the present disclosure;

FIG. 4 illustrates a quadrupole mass spectrometer coupled to a Knudsen cell type evaporator via differential pumping and skimmer according to the present disclosure;

FIG. 5 illustrates a sampling tube of a PVT system connected to a gas analyzer and maintained at elevated temperature using a heater inside of a vacuum chamber and connected to outside water-cooled feedthroughs according to the present disclosure;

FIG. 6a illustrates an example of an orifice and a skimmer divergent nozzle integrated into a sampling tube with the output of the skimmer connected to a quadrupole mass spectrometer and the output of the sampling tube connected to the differential pumping port according to the present disclosure; and

FIG. 6b illustrates an example of a sampling tube and skimmer divergent nozzle propagating through a mounting flange to be below a differential pumping port and not extending into the PVT chamber according to the present disclosure.

### DETAILED DESCRIPTION

The terminology used herein is for the purpose of describing particular embodiments only and is not intended to be limiting of the disclosure. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the disclosure, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion.

Nevertheless, the specification and claims should be read with the understanding that such combinations are entirely within the scope of the disclosure and the claims.

Novel devices and methods for sampling gas within a physical vapor transport system are discussed herein. In the following description, for purposes of explanation, numerous specific details are set forth in order to provide a thorough understanding of the present disclosure. It will be evident, however, to one skilled in the art that the present disclosure may be practiced without these specific details.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure relates to systems for providing a gas sample from a physical vapor transport system. The systems may include a sampling tube with a first end connected to a crucible retort of a physical vapor transport system to sample a gas phase. The systems may include a heater around at least a part of the sampling tube to maintain a temperature within the sampling tube. The sampling tube may be integrated with an orifice and a skimmer with a skimmer divergent nozzle. An output of the skimmer may be connected to a gas analyzer. An output of the sampling tube may be connected to a differential pumping port.

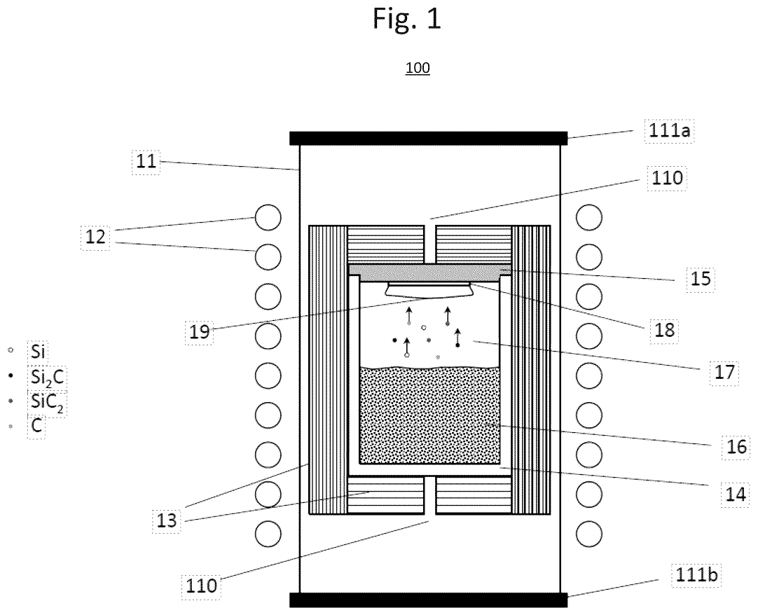

FIG. 1 illustrates an example PVT system or method that can be utilized to produce SiC bulk crystal boule growth according to the present disclosure and arranged in accordance with at least some embodiments presented herein.

System 100 may include a vacuum chamber 11 with a top flange 111a and a bottom flange 111b. A hot zone assembly may be located within vacuum chamber 11 and may include thermal insulation 13, a crucible retort 14, and a retort lid 15. Thermal insulation 13 may define openings 110 through thermal insulation 13 at a midpoint of a base of crucible retort 14 and at a midpoint of retort lid 15. System 100 may further include an induction coil 12 or resistive element outside of vacuum chamber 11.

Vacuum chamber 11 may be made of quartz and may be closed at top flange 111a and bottom flange 111b. Induction coil 12 or resistive element may heat crucible retort 14 and retort lid 15 of hot zone assembly. SiC source material 16 (polycrystalline power, pieces of polycrystalline SiC, or mix of high purity elemental Si and C) may be within crucible retort 14 and may sublimate at high temperatures upon heating to produce gas phase 17. Gas phase 17 may predominantly consist of Si, C, Si₂C and SiC₂, however, impurities from a graphite hot zone or process gas may be present in gas phase 17. System 100 may generate a thermal gradient between SiC source material 16 and a crystal seed 18 which may promote the deposition of SiC material 19 onto a surface of crystal seed 18. Analysis of the components within gas phase 17 may be beneficial towards producing a larger process window for depositing SiC crystals with a known crystal orientation and a low density of defects such as micropipes, dislocations, stacking faults, inversion domains, point defects and other defects.

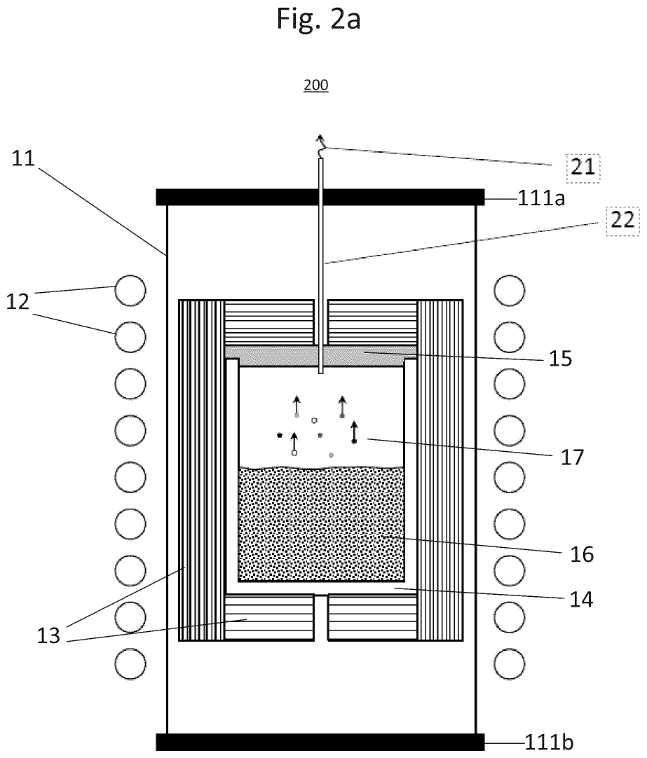

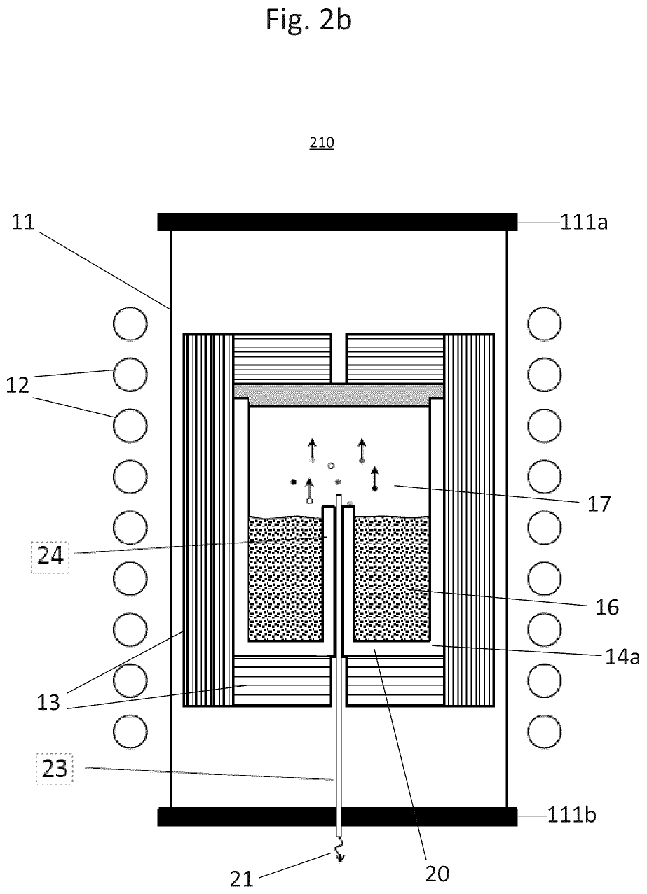

FIG. 2a illustrates a sampling tube for gas sampling from inside of a PVT system through the retort lid 15 of the crucible retort 14 according to the present disclosure, arranged in accordance with at least some embodiments presented herein. Those components in FIG. 2a that are labeled identically to components of FIG. 1 will not be described again for the purposes of brevity.

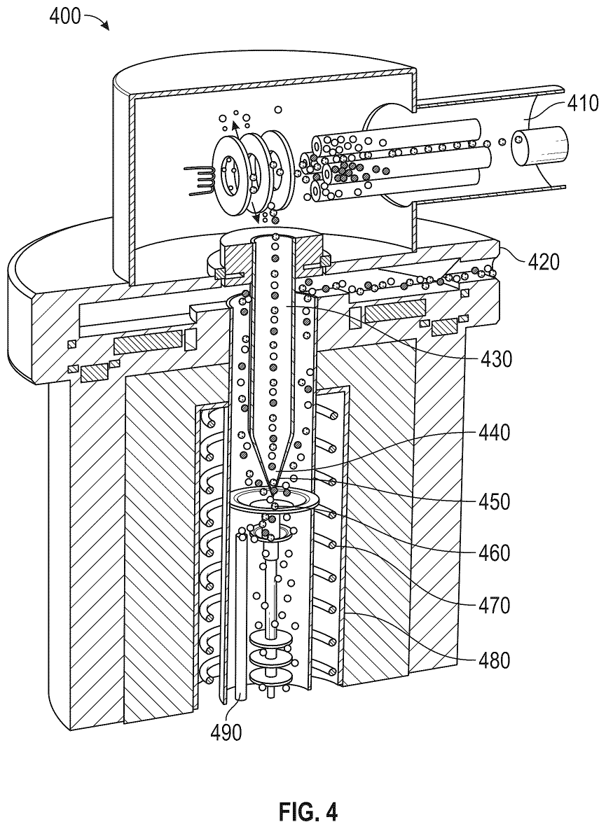

System 210 may include a sampling tube 22. Sampling tube 22 may pass through retort lid 15. Sampling tube 22 may sample gas 21 from gas phase 17 from inside of crucible retort 14 through retort lid 15. Sampling tube 22 may be a capillary tube used for sampling gas from a low vacuum compartment. When sampling compartment pressure (pressure within crucible retort 14) is higher than a typical gas analyzer pressure (below 10⁻⁴ Torr) sampling tube 22 may be used in conjunction with a differential pumping apparatus using a turbomolecular and/or rotary vacuum pump mounted at the entry of a gas analyzer (see, FIG. 4). A capillary sampling tube 22 with a differential pumping apparatus (FIG. 4) may work well for gaseous species sampling under medium vacuum level conditions in a sampled volume (typically 10⁻³ to 10⁻² Torr ).

In another embodiment, when sampling is performed upon highly condensable gases, such as those expected inside of crucible retort 14 at SiC PVT process conditions, a double stage pressure reduction may be required in addition to laminar flow capillary action of sampling tube 22. As described in more detail below, an orifice or a skimmer may be added to sampling tube 22 to provide a molecular leak for sample gas 21 to inlet into a high-vacuum recipient of a mass spectrometer for analysis.

FIG. 2b illustrates a sampling tube for gas sampling from inside of the crucible of a PVT system where a gas sampling tube is inserted through a bottom of a crucible modified with an element to maintain source material above the sampling tube according to the present disclosure, arranged in accordance with at least some embodiments presented herein. Those components in FIG. 2b that are labeled identically to components of FIGS. 1-2a will not be described again for the purposes of brevity.

System 210 may include a gas sampling tube 23. Gas sampling tube 23 may be inserted through a midpoint of a base 20 of a crucible retort 14a modified with element 24 to maintain source material (gas phase 17) above the sampling tube. Sampling tube 23 may sample gas 21 from gas phase 17 inside of crucible retort 14a to be analyzed. Sampling tube 23 may be a capillary tube used for sampling gas from a low vacuum compartment. When sampling compartment pressure (pressure within crucible retort 14a) is higher than a typical gas analyzer pressure (below 10⁻⁴ Torr) sampling tube 23 may be used in conjunction with a differential pumping apparatus using a turbomolecular and/or rotary vacuum pump mounted at the entry of a gas analyzer (see, FIG. 4). A capillary sampling tube 23 with a differential pumping apparatus may work well for gaseous species sampling under medium vacuum level conditions in a sampled volume (typically 10⁻³ to 10⁻² Torr ).

As previously stated, when sampling is performed upon highly condensable gases, such as those expected inside of crucible retort 14a at SiC PVT process conditions, a double stage pressure reduction may be required in addition to laminar flow capillary action of sampling tube 23. An orifice or a skimmer may be added to sampling tube 23 to provide a molecular leak for sample gas 21 to inlet into a high-vacuum recipient of a mass spectrometer (FIG. 4) for analysis.

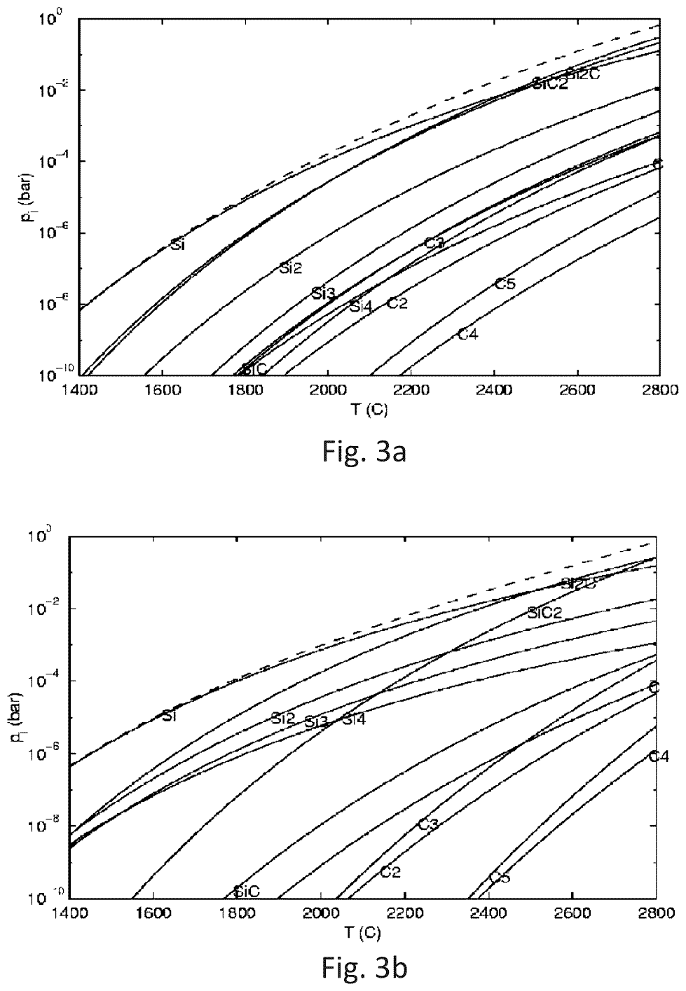

FIG. 3a illustrates calculated vapor pressure vs temperature curves for Si, C, Si₂C, SiC₂ and other compounds assuming condensed SiC and C according to the present disclosure. FIG. 3b illustrates calculated vapor pressure vs temperature curves for Si, C, Si₂C, SiC₂ and other compounds assuming condensed SiC and Si according to the present disclosure.

As shown in FIGS. 3a and 3b, calculated vapor pressure vs temperature curves for Si, C, Si₂C, SiC₂ and other compounds illustrate the relationship between vapor pressure and temperature for Si, C, Si₂C, SiC₂ and other compounds. These relationships between vapor pressure and temperature may be used to analyze materials and quantities within a gas sample.

FIG. 4 illustrates a quadrupole mass spectrometer coupled to a Knudsen cell type evaporator via a differential pump and a skimmer according to the present disclosure. Those components in FIG. 4 that are labeled identically to components of FIGS. 1-3 will not be described again for the purposes of brevity.

System 400 may include a Knudsen cell type evaporator including a quadrupole mass spectrometer (QMS) 410, an intermediate vacuum 420, a skimmer 430, a supersonic jet expansion zone 440, a divergent nozzle 450, a gas sample 460, a furnace 470, a sample holder 480, and a gas overflow capillary 190. Quadrupole mass spectrometer 410 may perform thermoanalytical techniques on gas sample 460 and may characterize solids and liquids within gas sample 460 with respect to their thermal behavior. Gas sample 460 may be moved to quadrupole mass spectrometer 410 through divergent nozzle 450, supersonic jet expansion zone 440, and skimmer 430. Gas sample 460 may encounter a pressure reduction from atmospheric pressure down to a vacuum of intermediate vacuum 420 behind an orifice of skimmer 430 in two steps along a distance of less than 20 mm which may reduce a risk of condensation and achieve a high detection sensitivity. When gas sample 460 includes highly condensable compounds, double orifice skimmer 430 may create gas species immediately in front of the first orifice to create molecular stream into intermediate vacuum 420 stage prior to quadrupole mass spectrometer 410. The design may allow for very short time of flight under nearly ideal gas conditions such that analyzed species get introduced into the analyzer before condensation. Commercially available Knudsen cell evaporators coupled with a skimmer based multiple stage pressure reduction system may be used for analysis of a small sample size of source material.

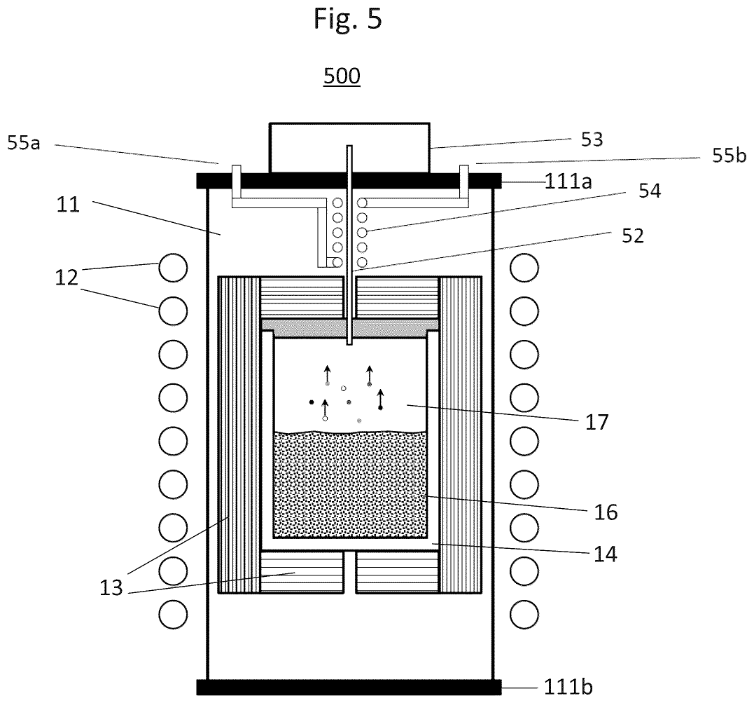

FIG. 5 illustrates a sampling tube of a PVT system connected to a gas analyzer and maintained at elevated temperature using a heater inside of a vacuum chamber and connected to outside water-cooled feedthroughs according to the present disclosure, arranged in accordance with at least some embodiments presented herein. Those components in FIG. 5 that are labeled identically to components of FIGS. 1-4 will not be described again for the purposes of brevity.

System 500 may include a sampling tube 52, a gas analyzer 53 and heater 54, and water-cooled feedthroughs 55a and 55b. Sampling tube 52 may be connected to gas analyzer 53. Sampling tube 52 may be maintained at an elevated temperature by heater 54. Heater 54 may be an inductive heater, resistive heater, or infrared heater. Heater 54 may be around at least part of sampling tube 52 and may be located inside of vacuum chamber 11 and connected to outside water-cooled feedthroughs 55a and 55b.

Sampling tube 52 may be a capillary tube and may be heated by heater 54 to a temperature of above 1400° C. Sampling tube 52 may be connected directly to crucible retort 14 with SiC source material 16. Sampling tube 52 heated by heater 54 to near process temperature of above 1400° C. may be used as a means of delivering species to an analyzer. Differential pumping may also be incorporated to achieve a higher pressure reduction.

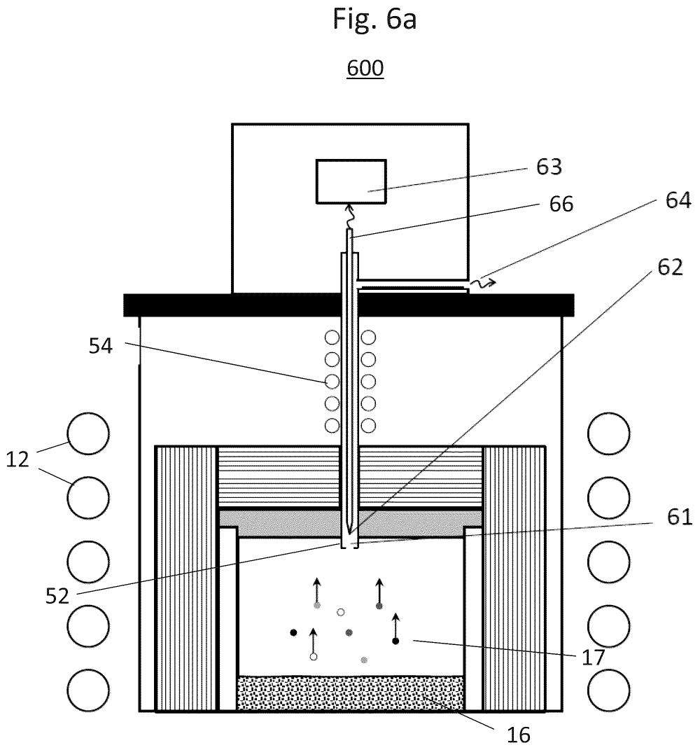

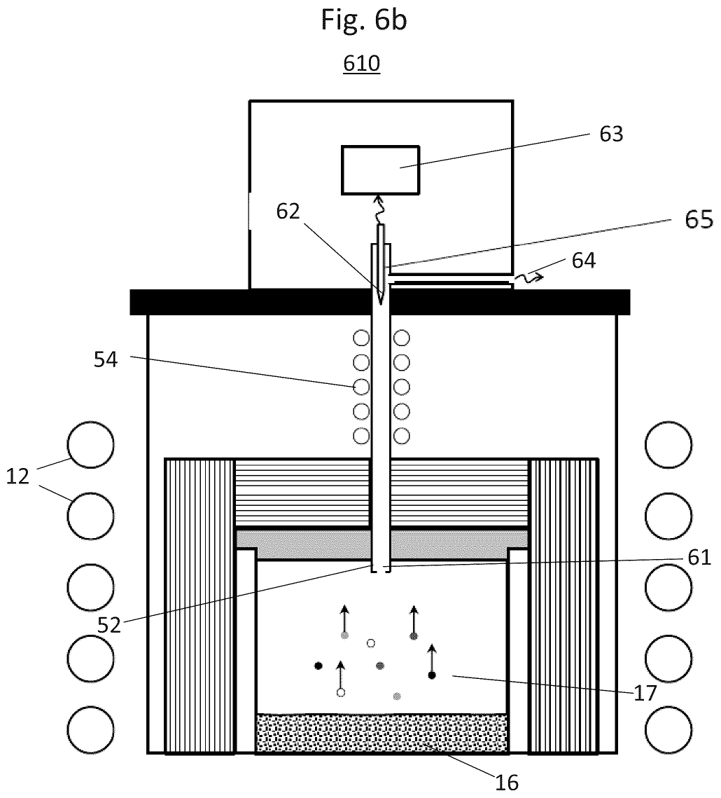

FIG. 6a illustrates an example of an orifice and a skimmer with a skimmer divergent nozzle integrated into a sampling tube with the output of the skimmer connected to a quadrupole mass spectrometer and the output of the sampling tube connected to the differential pumping port according to the present disclosure, arranged in accordance with at least some embodiments presented herein. Those components in FIG. 6a that are labeled identically to components of FIGS. 1-5 will not be described again for the purposes of brevity.

In system 600, an orifice 61 and a skimmer 66 with a skimmer divergent nozzle 62 may be integrated into sampling tube 52. Sampling tube 52 with integrated skimmer 66 and skimmer divergent nozzle 62 may produce a molecular jet of gas to be analyzed. Orifice 61 may be integrated at a first end of sampling tube 52. Sampling tube 52, skimmer 66 and skimmer divergent nozzle 62 may be fabricated from graphite, electrically conductive high temperature ceramic, or graphite or metal coated with a high temperature ceramic layer including but not limited to TaC, HfC, ZrC, TiC, WC and/or NbC or similar high temperature ceramic coatings. Skimmer 66 with skimmer divergent nozzle 62 may be integrated along about the full length of sampling tube 52. An output of skimmer 66 may be connected to a quadrupole mass spectrometer 63 and an output of sampling tube 52 may be connected to a differential pumping port 64. Differential pumping port 64 may be connected to differential pumping apparatus such as a turbomolecular and/or rotary vacuum pump.

Sampling tube 52 may be, for example, inductively heated using a water-cooled induction coil of heater 54 inside of the vacuum chamber operating at a frequency substantially different from PVT heating coil 12 frequency to minimize or eliminate cross talk between the two heating elements. Orifice 61 may provide a first stage of pressure reduction at the end of sampling tube 52 before gas entrance to the second stage Skimmer divergent nozzle 62 may be incorporated into sampling tube 52 such that it propagates into the reactor hot zone and is heated along the whole length between the hot zone and the entry to quadrupole mass spectrometer 63 mounted on a flange of the process tube. In this geometry, a molecular flow formed inside of skimmer 66 may be maintained at a temperature close to the process temperature along the majority of the path length.

FIG. 6b illustrates an example of a sampling tube and skimmer divergent nozzle propagating through a mounting flange to be below a differential pumping port and not extending into the PVT chamber according to the present disclosure, arranged in accordance with at least some embodiments presented herein. Those components in FIG. 6b that are labeled identically to components of FIGS. 1-6a will not be described again for the purposes of brevity.

In system 610, a skimmer 65 with a skimmer divergent nozzle 62 may be integrated into sampling tube 52. Sampling tube 52 with integrated skimmer 65 and skimmer divergent nozzle 62 may produce a molecular jet of gas to be analyzed. Skimmer divergent nozzle 62 may propagate through a mounting flange and extend only to have the skimmer divergent nozzle below differential pumping port 64 but may not extend into the PVT chamber. Sampling tube 52, skimmer 65 and skimmer divergent nozzle 62 may be fabricated from graphite, electrically conductive high temperature ceramic, or graphite or metal coated with a high temperature ceramic layer including but not limited to TaC, HfC, ZrC, TiC, WC and/or NbC or similar high temperature ceramic coatings. An output of skimmer 65 may be connected to quadrupole mass spectrometer 63 and an output of sampling tube 52 may be connected to differential pumping port 64.

A system in accordance with the present disclosure may provide functional gas samples to a quadrupole mass spectrometer for analysis of the presence (or partial pressure) of various species inside the crucible of a PVT system.

It may be beneficial to mount the sampling tube 52, skimmer 65 and skimmer divergent nozzle 62 at the bottom flange of the vacuum chamber to enable gas analysis during PVT deposition run with fully loaded seed material. It should be understood that inlet of the capillary tube or the orifice of the sampling tube will, thereby, be located in a higher temperature zone compared to the top of the crucible, where crystal seed is mounted. This is expected to minimize deposition of SiC material onto the capillary tube and/or orifice of the sampling tube.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The embodiments described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A system for providing a gas sample from a physical vapor transport system, the system comprising:
a sampling tube with a first end connected to a crucible retort of the physical vapor transport system to sample a gas phase; and
a heater around at least a part of the sampling tube to maintain a temperature within the sampling tube,
wherein the sampling tube is integrated with an orifice and a skimmer with a skimmer divergent nozzle, an output of the skimmer is connected to a gas analyzer, and an output of the sampling tube is connected to a differential pumping port.

2. The system of claim 1, wherein the sampling tube is a capillary tube.

3. The system of claim 1, wherein the gas analyzer is a quadrupole mass spectrometer.

4. The system of claim 1, wherein the sampling tube passes through a lid of the crucible retort.

5. The system of claim 1, wherein the sampling tube is inserted through a bottom of the crucible retort and the crucible retort includes an element to maintain a source material above the sampling tube.

6. The system of claim 1, wherein a source material within the crucible retort is SiC source material including a polycrystalline power, pieces of polycrystalline SiC, or a mix of high purity elemental Si and C.

7. The system of claim 1, wherein the gas phase includes Si, C, Si₂C and SiC₂.

8. The system of claim 1, wherein the heater is an inductive heater, resistive heater, or infrared heater, and heats the sampling tube to a temperature of above 1400° C.

9. The system of claim 1, wherein the differential pumping port is connected to differential pumping apparatus including a turbomolecular and/or rotary vacuum pump.

10. The system of claim 1, wherein the skimmer with the skimmer divergent nozzle is integrated along about a full length of the sampling tube and form a molecular jet of gas to be analyzed.

11. The system of claim 1, wherein the skimmer with the skimmer divergent nozzle is integrated along a portion of a length of the sampling tube to be below the differential pumping port but does not extend into the crucible retort and form a molecular jet of gas to be analyzed.

12. The system of claim 1, wherein the sampling tube integrated with an orifice and a skimmer with a skimmer divergent nozzle are fabricated from graphite, electrically conductive high temperature ceramic, or graphite or metal coated with a high temperature ceramic layer including TaC, HfC, ZrC, TiC, WC, and/or NbC.

13. A device for providing a gas sample from a physical vapor transport system, the device comprising:
a sampling tube integrated with an orifice and a skimmer with a skimmer divergent nozzle; and
a heater around at least a part of the sampling tube to maintain a temperature within the sampling tube,
wherein a first end of the sampling tube is connected to a crucible retort of the physical vapor transport system to sample a gas phase, an output of the skimmer is connected to a gas analyzer, and an output of the sampling tube is connected to a differential pumping port.

14. The device of claim 13, wherein the sampling tube passes through a lid of the crucible retort.

15. The device of claim 13, wherein the sampling tube is inserted through a bottom of the crucible retort and the crucible retort includes an element to maintain a source material above the sampling tube.

16. The device of claim 13, wherein the skimmer with the skimmer divergent nozzle is integrated along about a full length of the sampling tube and form a molecular jet of gas to be analyzed.

17. The device of claim 13, wherein the skimmer with the skimmer divergent nozzle is integrated along a portion of a length of the sampling tube with the skimmer divergent nozzle below the differential pumping port but not extending into the crucible retort and form a molecular jet of gas to be analyzed.

18. The device of claim 13, wherein a source material within the crucible retort is SiC source material including a polycrystalline power or a mix of high purity elemental Si and C.

19. The device of claim 13, wherein the gas phase includes Si, C, Si₂C and SiC₂.

20. A method for providing a gas sample from a physical vapor transport system, the method comprising:
sampling gas from a gas phase of a crucible retort of the physical vapor transport system by a sampling tube integrated with an orifice and a skimmer with a skimmer divergent nozzle, wherein a first end of the sampling tube is connected to the crucible retort of the physical vapor transport system, an output of the skimmer is connected to a gas analyzer, and an output of the sampling tube is connected to a differential pumping port;
heating the sampling tube by a heater around at least a part of the sampling tube to maintain a temperature within the sampling tube; and
providing the sampled gas to the gas analyzer.
